(19) United States
(12) Patent Application Publication
(10) Pub. No.: US 2024/0357318 A1
(43) Pub. Date: Oct. 24, 2024

(54) SYSTEM AND METHOD OF DETERMINING MICRO MOBILITY VEHICLE RIDING LOCATION

(71) Applicant: VComm Smart Transportation LTD., Gilon (IL)

(72) Inventors: Dror STEINMETZ, Tel-Aviv (IL); Nimrod SEGEV, Gilon (IL)

(21) Appl. No.: 18/641,389

(22) Filed: Apr. 21, 2024

(30) Foreign Application Priority Data
Apr. 23, 2023 (IL) 302358

(51) Int. Cl. H04W 4/02; H04W 4/029

(52) U.S. Cl. CPC H04W 4/025; H04W 4/029

(57) ABSTRACT

A system and method of determining a vehicle's location by at least one processor may include receiving a motion signal from a motion detector associated with a first vehicle; calculating a motion data element, representing motion characteristics of the first vehicle, based on the motion signal; based on the motion data element, calculating a ramp traversal score, representing probability of traversal of the first vehicle over a ramp; and analyzing the ramp traversal score, to determine location of the first vehicle in relation to a sidewalk.

### CROSS-REFERENCE TO RELATED APPLICATIONS

This application claims the benefit of Israeli Patent Application No. 302358, filed Apr. 23, 2023, and titled: “SYSTEM AND METHOD OF DETERMINING MICRO MOBILITY VEHICLE RIDING LOCATION”, which is hereby incorporated by reference in its entirety.

### FIELD OF THE INVENTION

The present invention relates generally to smart city technology. More specifically, the present invention relates to determining location of a vehicle.

### BACKGROUND OF THE INVENTION

The abundance of electric micro mobility vehicles, such as electric scooters, bicycles, and skateboards in urban districts has proved to be a double-edged sword: on one hand, such vehicles have widened the range of accessibility for pedestrians, and allowed commuters to utilize public transportation effectively. On the other hand, unregulated usage of micro mobility vehicles has led to public hazard and nuisance, for example by irresponsible riders who take control over pedestrian sidewalks.

Currently available systems and methods for monitoring and regulating micro mobility vehicle conduct employ various methods of identifying sidewalk riding.

For example, currently available methods may analyze output of Light Detection And Ranging (LIDAR) or imaging systems, to determine location of the vehicle in relation to a sidewalk. Other methods may compare Global Positioning System (GPS) data to information stored on urban maps, to identify sidewalk riding.

Other methods of identifying sidewalk riding analyze sensor signals to determine whether a vehicle of interest is riding over a surface that is characterized by a specific structure, such as a tiled sidewalk, having repetitive gaps.

Currently available technology for identifying sidewalk riding typically experience inherent difficulties. For example, imaging and LIDAR systems provide poor accuracy due to Line of sight issues, especially in bustling urban regions. In another example, systems that rely on identification of riding surfaces, such as tiled sidewalks, typically experience difficulties due to variation of these surface, and the interaction of different micro mobility vehicles with these surfaces. In yet another example, systems which rely on accurate location of vehicles of interest to determine whether that vehicle is in fact riding on a sidewalk typically experience poor performance due to difficulties in accurate global positioning in urban areas stemming from satellite signal reflection and occluded line of sight. Such difficulties hinder the ability of current technological solutions to identify sidewalk riding, and identify rider misconduct.

It may be appreciated that such systems may require dedicated hardware, and online analysis of that data, which may not be readily available for each micro mobility platform or may not accurately define characteristics of sidewalk riding.

### SUMMARY OF THE INVENTION

Embodiments of the invention may include a method of determining a vehicle's location, e.g., on a ramp or a sidewalk by at least one processor. As elaborated herein, embodiments of the invention may employ a synergy, and feedback between three different processes, relating to a plurality of information sources, to identify micro mobility sidewalk riding.

A first such process includes analysis of signals obtained from vehicle-mounted, inexpensive physical sensors as elaborated herein (e.g., in relation to signal analysis module 40). This information may be analyzed to identify ramp traversal by the relevant vehicle. It has been experimentally observed by the inventors that determination of ramp traversal by such physical sensors may be less error-prone than direct assessment of sidewalk riding based on the same sensors.

A second such process may employ analysis of big-data information that may represent ramp traversal data from a plurality of users, also referred to herein as “crowd sourcing” as elaborated herein (e.g., in relation to ramp identifier module 110).

A third such process may employ analysis of big-data information that may represent ramp traversal data and sidewalk-riding parameters obtained from a plurality of users (“crowd-sourcing”), to ascertain a location (e.g., on, or off a sidewalk) of a vehicle of interest, as elaborated herein (e.g., in relation to sidewalk identifier module 120).

It may be appreciated that synergy among these three processes may incrementally improve the individual performance of each process on one hand, and improve prediction of location (e.g., on, or off a sidewalk) of a vehicle of interest, on the other hand.

According to some embodiments, the at least one processor may receive a motion signal from a motion detector associated with a first vehicle, and calculate a motion data element, representing motion characteristics of the first vehicle, based on the motion signal. Based on the motion data element, the at least one processor may calculate a ramp traversal score, representing probability of traversal of the first vehicle over a ramp, and analyze the ramp traversal score, to determine location of the first vehicle in relation to a sidewalk.

According to some embodiments, the motion detector may be installed on the first vehicle, and may be selected from a list consisting of an accelerometer, configured to produce an acceleration motion signal, and a gyroscope configured to produce an orientation motion signal, and wherein the motion data element may be respectively selected from a list consisting of an acceleration data element and an orientation data element.

According to some embodiments, the at least one processor may calculate the ramp traversal score by identifying, in the acceleration data, an impact event representing acceleration of the first vehicle, characteristic of impact with an edge of a ramp; identifying, in the orientation data, a slope event representing orientation of the first vehicle, characteristic of a slope of a ramp; and calculating an initial value of the ramp traversal score based on the slope event and the impact event.

According to some embodiments, the at least one processor may assign a first timestamp to the impact event; assign a second timestamp to the slope event; and calculate the initial value of the ramp traversal score further based on the first timestamp and second timestamp.

Additionally, or alternatively, the at least one processor may obtain a geoinformation data element representing byways at a predefined geographical region; and receive, from a geolocation device, a geolocation data element representing geolocation of the first vehicle. Based on the ramp traversal score and the geolocation data element, the at least one processor may augment the geoinformation data element to include a label of a ramp at a position corresponding to the geolocation of the first vehicle.

According to some embodiments, the at least one processor may calculate the ramp traversal score by: based on the geolocation data element, calculating a ramp-vicinity score, representing vicinity of the first vehicle to a location of a previously labeled ramp in the geoinformation data element; and inferring a first machine-learning (ML) based model on at least one of (i) the motion data element of the first vehicle, (ii) the ramp-vicinity score, and (iii) the initial value of the ramp traversal score, to recalculate the ramp traversal score.

According to some embodiments, the location of the previously labeled ramp may correspond to geolocation of one or more second vehicles.

According to some embodiments, the at least one processor may augment the geoinformation data element to include a label of a ramp at a position corresponding to the geolocation of the first vehicle, based on (i) the recalculated ramp traversal score and (ii) the geolocation data element.

According to some embodiments, the at least one processor may determine location of the first vehicle in relation to the sidewalk by: based on the ramp traversal score, calculating a traversal state value, representing a timewise sequence of one or more ramp ascents or ramp descents; and based on the traversal state value, calculating an initial value of sidewalk probability, representing probability of location of the first vehicle on the sidewalk.

According to some embodiments, the timewise sequence may include, for example a ramp ascent, a ramp ascent followed by ramp descent within a predefined timeframe, a ramp descent, and a ramp descent followed by ramp ascent within a predefined timeframe.

According to some embodiments, the at least one processor may be configured to augment the geoinformation data element to include a label of a sidewalk, corresponding to geolocation of the first vehicle, based on (i) the initial sidewalk probability value, and (ii) the geolocation data element.

Additionally, or alternatively, the at least one processor may be configured to: based on the geolocation data element, calculating a sidewalk-vicinity score, representing vicinity of the first vehicle to a location of a previously labeled sidewalk in the geoinformation data element; and inferring a second ML based model on at least one of (i) the sidewalk-vicinity score, (ii) the traversal state value, and (iii) the initial sidewalk probability value, to recalculate the sidewalk probability value.

According to some embodiments, the location of the previously labeled sidewalk may correspond to geolocation of one or more second vehicles.

According to some embodiments, the at least one processor may be configured to calculate one or more sidewalk-riding parameters, based on the motion data element when the sidewalk probability value surpasses a predefined threshold. Based on the geolocation data, the at least one processor may augment the geoinformation data element to include a sidewalk signature, representing the one or more sidewalk-riding parameters, at a location corresponding to the geolocation of the first vehicle.

According to some embodiments, the at least one processor may calculate one or more current riding parameters based on the motion data. The at least one processor may subsequently extract at least one sidewalk signature from the geoinformation data element based on the geolocation data. The at least one processor may further infer the second ML model on (i) the one or more current riding parameters, and/or (ii) the extracted sidewalk signature, to recalculate the sidewalk probability value.

Additionally, or alternatively, the at least one processor may infer the first ML based model further on the sidewalk probability value, to recalculate the ramp traversal score.

Embodiments of the invention may include a system for determining a vehicle's location. Embodiments of the system may include a motion detector associated with a first vehicle, and configured to produce a motion signal, and a first client computing device, associated with the first vehicle. The first client computing device may include a non-transitory memory device, wherein modules of instruction code are stored, and at least one first processor, associated with the memory device. The at least one first processor may be configured to execute the modules of instruction code. Upon execution of said modules of instruction code, the at least one first processor may be configured to: receive a motion signal from the motion detector; calculate a motion data element, representing motion characteristics of the first vehicle, based on the motion signal; based on the motion data element, calculate a ramp traversal score, representing probability of traversal of the first vehicle over a ramp; and analyze the ramp traversal score, to determine location of the first vehicle in relation to a sidewalk.

Additionally, or alternatively, the at least one first processor may be further configured to: receive, from a geolocation device, a geolocation data element representing geolocation of the first vehicle; obtain, from a server computing device, a geoinformation data element representing a predefined geographical region surrounding the geolocation of the first vehicle; and transmit the ramp traversal score and the geolocation data element to the server computing device. The server computing device may be configured to augment the geoinformation data element to include a label of a ramp at a position corresponding to the geolocation of the first vehicle, based on the ramp traversal score.

Embodiments of the invention may include a system for determining a vehicle's location. Embodiments of the system may include a server computing device. The server computing device may include a non-transitory memory device, wherein modules of instruction code are stored, and at least one processor, associated with the memory device. The at least one processor may be configured to execute the modules of instruction code. Upon execution of said modules of instruction code, the at least one processor may be configured to: maintain a geoinformation data element, representing position of one or more ramps at a predetermined geographical region; receive, from a first client computing device associated with a first vehicle, a geolocation data element representing geolocation of the first vehicle; receive, from the first client computing device, a ramp traversal score, representing probability of traversal of the first vehicle over a ramp; and based on the ramp traversal score, augmenting the geoinformation data element, to include a label of a ramp at a position corresponding to the geolocation of the first vehicle, based on the ramp traversal score.

Embodiments of the invention may include a method of determining a vehicle's location by at least one processor. According to some embodiments, the at least one processor may receive a geolocation data element representing geolocation of a first vehicle, and receive a motion signal from a motion detector associated with the first vehicle. The at least one processor may calculate a motion data element, representing motion characteristics of the first vehicle, based on the motion signal. Based on the motion data element, the at least one processor may calculate an initial value of a ramp traversal score, representing probability of traversal of the first vehicle over a ramp. The at least one processor may subsequently calculate a ramp-vicinity score representing vicinity of the first vehicle to a location of a ramp, based on the geolocation data element.

According to some embodiments, the at least one processor may infer a first ML-based model (e.g., also referred to herein as a “ramp” ML model) on the ramp-vicinity score and on at least one of (i) the motion data element and (ii) the initial value of the ramp traversal score, to update the ramp traversal score. The at least one processor may then determine location of the first vehicle in relation to a sidewalk based on the updated ramp traversal score.

According to some embodiments, the at least one processor may obtain a geoinformation data element representing byways at a predefined geographical region. Based on (i) the ramp traversal score, and (ii) the geolocation data element, the at least one processor may augment the geoinformation data element to include a label of a ramp at a position corresponding to the geolocation of the first vehicle. The at least one processor may subsequently calculate the ramp-vicinity score based on location of a previously labeled ramp (e.g., obtained via another vehicle or at a previous point in time) in the augmented geoinformation data element.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for determining location of a vehicle according to some embodiments;

FIG. 2A is a block diagram, depicting an example of implementation of a system for determining location of a vehicle, according to some embodiments;

FIG. 2B is a block diagram, depicting another example of implementation of a system for determining location of a vehicle, according to some embodiments;

FIG. 3 is a block diagram, depicting an example of implementation of aspects of a system for determining location of a vehicle, according to some embodiments;

FIG. 4, is a block diagram depicting an example of implementation of a sidewalk identification module, which may be included in a system for determining location of a vehicle, according to some embodiments of the invention; and

FIG. 5 is a flow diagram, depicting a method of determining location of a vehicle, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

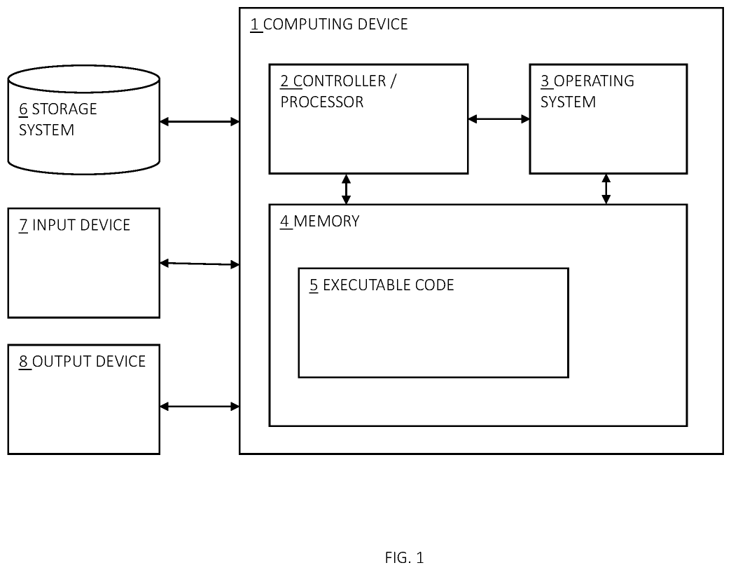

Reference is now made to FIG. 1, which is a block diagram depicting a computing device, which may be included within an embodiment of a system for determining location of a vehicle, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may determine location of a vehicle as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Geoinformation data may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

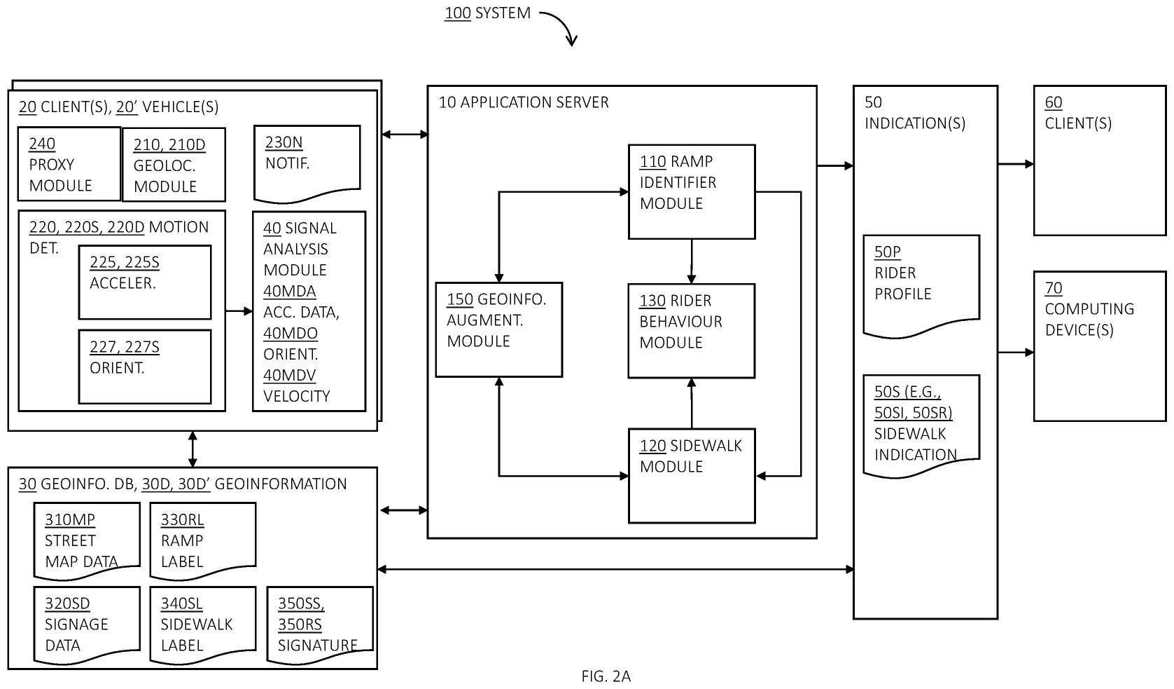

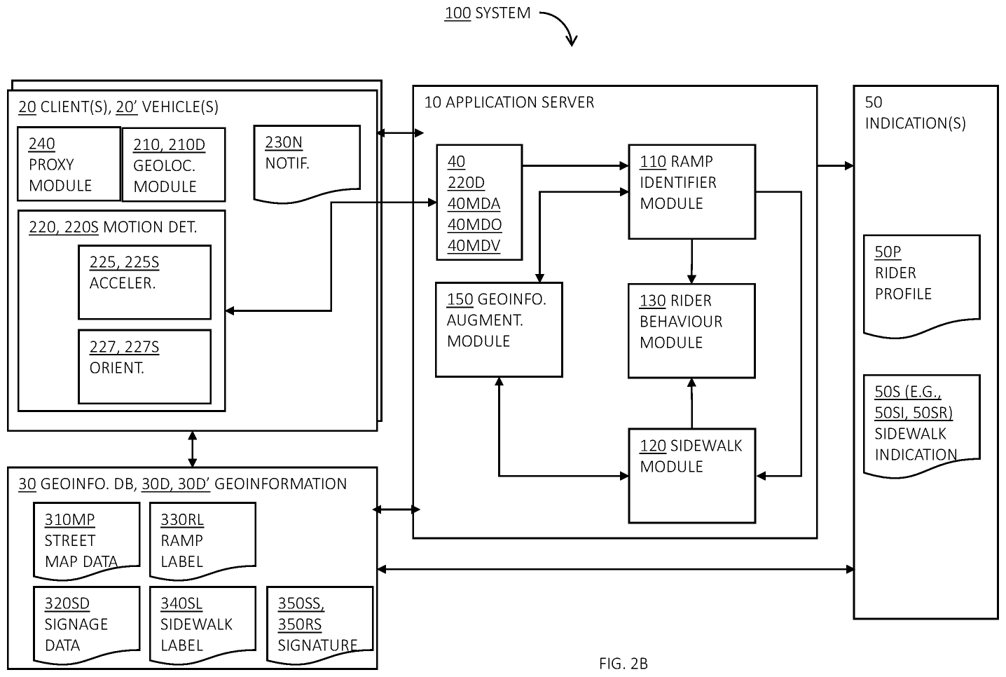

Reference is now made to FIGS. 2A and 2B, which are a block diagrams, depicting examples of implementation of a system 100 for determining location of a vehicle, according to some embodiments. As shown in FIGS. 2A and 2B, arrows may represent flow of one or more data elements to and from system 100 and/or among modules or elements of system 100. Some arrows have been omitted in FIGS. 2A and 2B for the purpose of clarity.

According to some embodiments of the invention, system 100 may be implemented as a software module, a hardware module, or any combination thereof. For example, system 100 may be or may include a computing device such as element 1 of FIG. 1, and may be adapted to execute one or more modules of executable code (e.g., element 5 of FIG. 1) to determine location of a vehicle, as further described herein.

In the non-limiting example of FIGS. 2A and 2B, system 100 may be implemented as a server-client system, where one or more (e.g., a plurality of) client computing devices 20 (e.g., computing devices 1 of FIG. 1, or “clients 20” for short) may be communicatively connected via a communication network to at least one server computing device 10 (e.g., computing devices 1 of FIG. 1) also referred to herein as application server 10. For example, the communication network may be the Internet and/or a cellular network, and client computing devices 20 may communicate information to application server 10 via an Internet of Things (IoT) protocol.

In such embodiments, server computing device 10 may be a cloud-based server or that may be implemented by one or more distributed computing devices, adapted to serve the plurality of client devices 20 as known in the art.

At least one (e.g., each) client 20 may be associated with, or installed on at least one respective vehicle 20′. The terms “vehicle” 20′ and “client” 20 may therefore be used interchangeably when referring to geolocation and/or motion properties of these elements. Vehicles 20′ may be, for example micro mobility vehicles, such as electric scooters, bicycles, and skateboards.

As shown in FIGS. 2A and 2B, one or more vehicles 20′ may include, or may be associated with one or more motion detection modules 220 (or “motion detectors” 220), configured to continuously (e.g., repeatedly, over time) produce motion signals 220S, representing or encoding properties of motion of the respective vehicle 20′.

As shown in FIG. 2A, client 20 may include a signal analysis module 40, adapted to analyze motion signals 220S to calculate a motion data element 220D representing motion of the vehicle 20′.

Motion detectors 220 may include, for example Internet Of Things (IoT) devices, adapted to measure data characteristics of motion (e.g., acceleration, velocity, orientation, etc.), and communicate motion data element 220D to client 20 and/or to an online server 10 via a communication network (e.g., cellular network, the Internet, etc.), to be processed as elaborated herein. Additionally, or alternatively, motion detectors 220 may be included, or integrated in a mobile device (e.g., a cellular phone), and may communicate motion data element 220D to client 20 and/or to online server 10 via the communication network (e.g., cellular network, the Internet, etc.), to be processed as elaborated herein.

For example, motion detection modules 220 may be, or may include one or more accelerometer modules 225 installed on, or embedded in vehicle 20′. Motion detectors 220 (accelerometer modules 225) may be configured to produce motion signals 220S that are accelerometer signals 225S, representing acceleration of vehicle 20′ in one or more axes of motion (e.g., vertical, frontal and sagittal axes). Signal analysis module 40 may analyze accelerometer signals 225S, to produce digital acceleration data 40MDA, representing acceleration of vehicle 20′ in the one or more axes of motion. Additionally, or alternatively, accelerometer modules 225 may be configured to produce digital acceleration data 220D, and provide digital acceleration data 220D to a processor (e.g., processor 2 of FIG. 1) of client computing device 20, as digital acceleration data 40MDA. It may be appreciated that acceleration data 40MDA may also include data representing velocity and/or location or translation of client 20, through solution of motion equations, as known in the art.

Additionally, or alternatively, motion detection modules 220 may be, or may include one or more orientation detection modules such as a gyroscope 227 installed on, or embedded in vehicle 20′. Motion detectors 220 (orientation detectors 227) may be configured to produce motion signals 220S that are orientation signals 227S, representing orientation of vehicle 20′ in one or more axes of orientation (e.g., pitch, yaw and roll axes). Signal analysis module 40 may analyze orientation signals 227S, to produce digital orientation data 40MDO, representing orientation of vehicle 20′ in the one or more axes of orientation. Additionally, or alternatively, gyroscope modules 227 may be configured to produce digital orientation data 220D, and provide digital orientation data 220D to a processor (e.g., processor 2 of FIG. 1) of client computing device 20, as digital orientation data 40MDO.

Additionally, or alternatively, and as shown in the example of FIG. 2B, signal analysis module 40 may be implemented, or included in server 10. In such embodiments, client 20 may continuously (e.g., periodically, or event-triggered) transmit motion signals 220S to server 10. Signal analysis module 40 of server 10 may analyze motion signals 220S to calculate motion data elements 220D, 40MDO and/or 40MDA, representing motion of the vehicle 20′.

Additional implementations of system 100 may include signal analysis module 40 implemented, or included in both server 10 and in one or more individual client computing devices 20 (e.g., combining the examples of FIG. 2A and FIG. 2B).

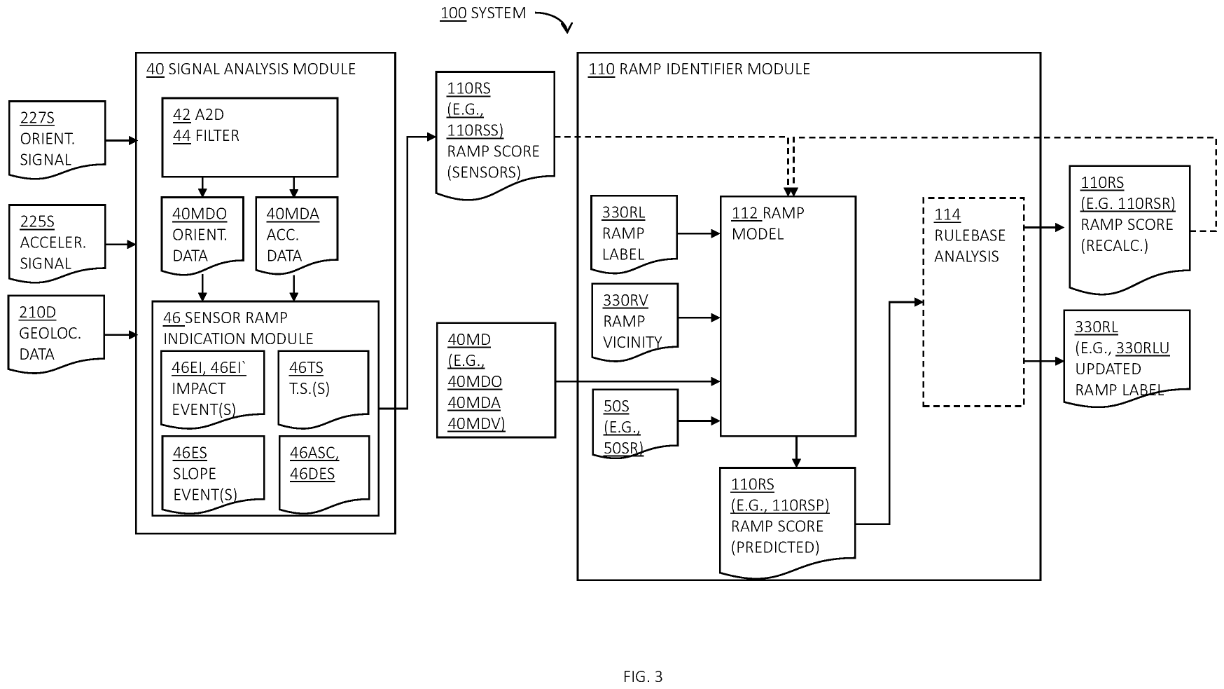

Reference is also made to FIG. 3, which is a block diagram, depicting a non-limiting example of implementation of aspects of system 100 for determining location of a vehicle, according to some embodiments. System 100 of FIG. 3 may be the same system 100 of FIG. 2A or FIG. 2B. Some arrows and modules have been omitted in FIG. 3 for the purpose of clarity.

As shown in the example of FIG. 3, signal analysis module 40 may include a sensor ramp indication module 46 (or “module 46”, for short), configured to calculate a ramp traversal score 110RS, representing probability of traversal of vehicle 20′ over a ramp based on the motion data elements (e.g., 40MDA, 40MDO).

The term “ramp” may be used herein to refer to a sloped step that may connect between a road, and an elevated sidewalk, so as to allow smooth traversal between the two by road users such as micro mobility vehicles, bicycles, trollies, and the like.

As elaborated herein, system 100 may use ramp traversal score 110RS to determine geographical location of one or more ramps in a geographical region, such as an urban, residential or commercial region. System 100 may utilize a crowd-source paradigm to repeatedly, or iteratively recalculate ramp traversal score 110RS based on information obtained from a plurality of clients 20 (and respective vehicles 20′) and/or over different instances in time. In other words, system 100 may refine the determination of location of ramps over time, and/or based on a plurality of data sources. The term “ramp traversal score 110RS” may thus refer to the same data element in different stages of calculation. These stages are denoted herein as 110RSS, 110RSP, and 110RSR.

According to some embodiments, module 46 may calculate a first, or initial version of ramp traversal score 110RS, denoted herein as ramp traversal score 110RSS, based on motion data elements (e.g., 40MDA, 40MDO). It has been experimentally observed that traversal of a ramp may include identifiable, learnable, motion (e.g., acceleration, orientation) characteristics, that are different from motion characteristics of non-ramp obstacles (e.g., rocks, potholes, etc.).

For example, traversal of a ramp may be characterized by an impact, or “bump”, which may be detected by an acceleration sensor, and a change in orientation (e.g., pitch), which may be detected by an orientation sensor. Module 46 may exploit this observation to identify traversal of a ramp by vehicle 20′.

Module 46 may identify, in acceleration data 40MDA, an impact event 46EI representing acceleration of the first vehicle, characteristic of impact with an edge of a ramp. Impact event 46EI may be characterized by acceleration 40MDA that exceeds a predefined threshold. Additionally, or alternatively, module 46 may identify, in the orientation data 40MDO a slope event 46ES representing orientation of vehicle 20′, characteristic of a slope of a ramp. For example, slope event 46ES may be characterized by a pitch orientation within a predefined range. Module 46 may subsequently calculate an initial value 110RSS of ramp traversal score 110RS based on slope event 46ES and impact event 46EI, e.g., as a function of resemblance between (i) motion data elements 40MDO, 40MDA and (ii) expected values of orientation and/or acceleration, in slope event 46ES and impact event 46EI.

It has been experimentally observed that traversal of a ramp may be characterized by a specific sequence of events, e.g., a bump event, preceded by, or followed by a slope event. In contrast, traversal of a mere bump, or pothole is typically recorded as a bump event, devoid of a preceding, or subsequent slope event.

For example, ascent of a ramp by vehicle 20′ may include an impact event 46EI (e.g., a “bump”), followed by a slope event 46ES (in which vehicle 20′ may ascend via the ramp onto a sidewalk) within a first predetermined timeframe (e.g., determined by a speed of vehicle 20′).

In another example, descent of a ramp by vehicle 20′ may include a slope event 46ES (in which vehicle 20′ may descend via the ramp from a sidewalk), followed by an impact event 46EI (e.g., a “bump”, indicating impact of vehicle 20′ on the road), within a second predetermined timeframe (e.g., determined by a speed of vehicle 20′).

Accordingly, module 46 may assign a first timestamp 46TS to the impact event 46EI, assign a second timestamp 46TS to the slope event 46ES, and calculate the initial value 110RSS of ramp traversal score 110RS further based on the first timestamp 46TS and second timestamp 46TS. In other words, module 46 may identify an event of ramp traversal as one of ramp ascent 46ASC, or ramp descent 46DES based on an order of impact event 46EI and slope event 46ES.

Additionally, module 46 may calculate the initial value 110RSS of ramp traversal score 110RS as a function of similarity between (i) a time difference between first timestamp 46TS and second timestamp 46TS, and (ii) an expected, predetermined time difference that may indicate a ramp ascent 46ASC or ramp descent 46DES event (e.g., as opposed to “occasional” bump events, e.g., due to running over rocks, bumpers or potholes.

Additionally, or alternatively, module 46 may send records of impact events 46EI, that are not related to ramp ascent 46ASC or ramp descent 46DES events (e.g., not adjacent slope events 46ES) and denoted herein as 46EI′, alongside respective geolocation data 210D to server 10. Server 10 may store the location (represented by 210D) of these non-ramp impact events 46EI′ in a database such as element 6 of FIG. 1.

As elaborated herein, server 10 may also use these non-ramp impact events 46EI′ to continuously augment (e.g., by augmentation module 150) street-map data, with information of bumps or potholes. Additionally, and as elaborated herein, server 10 may use these non-ramp impact events 46EI′ as negative examples for training a machine learning model 112 to identify location of ramps.

According to some embodiments, system 100 may analyze ramp traversal score 110RS to determine a sidewalk probability data element 50S, representing location of vehicle 20′ in relation to a sidewalk. System 100 may also produce, or transmit sidewalk probability data element 50S as an indication of riding on a sidewalk (e.g., via output device 8 of FIG. 1). The terms “sidewalk probability data element 50S” and “sidewalk indication 50S” may therefore be used interchangeably in this context.

According to some embodiments sidewalk indication 50S may for example, include a Boolean value, where ‘1’ indicates that vehicle 20′ is currently riding on a sidewalk, and ‘0’ indicates that vehicle 20′ is currently not riding on a sidewalk (e.g., riding on a road).

System 100 may utilize a crowd-source paradigm to repeatedly, or iteratively recalculate sidewalk probability 50S based on information obtained from a plurality of clients 20 (and respective vehicles 20′), and/or over different instances in time. In other words, system 100 may refine the determination of location of sidewalks over time, and/or based on a plurality of data sources. The term “sidewalk probability 50S” may thus refer to the same data element in different stages of calculation. These stages are denoted herein as 50SI, 50SP, and 50SR.

According to some embodiments, sidewalk probability data elements 50S (e.g., 50SI, 50SP, 50SR) may have a floating value in the range of [0, 1], where for example ‘0.1’ represents low probability that vehicle 20′ is riding a sidewalk, and ‘0.9’ represents high probability that vehicle 20′ is riding a sidewalk. Additionally, or alternatively, sidewalk probability data elements 50S (e.g., 50SI, 50SP, 50SR) may have a binary value, where ‘0’ indicates that vehicle 20′ is not riding a sidewalk, and ‘1’ indicates that vehicle 20′ is riding a sidewalk.

According to some embodiments, client 20 may analyze ramp traversal score 110RS to produce an initial value 50SI of sidewalk indication or sidewalk probability 50S (representing location of vehicle 20′ in relation to a sidewalk) locally, and may transmit sidewalk indication 50SI to server 10.

For example, in an initial iteration, (e.g., when ramp traversal score 110RS is obtained as 110RSS from sensor ramp 46), signal analysis module 40 may set sidewalk indication 50S based on, or following detection of a ramp ascent event 46ASC or ramp descent 46DES event. For example, signal analysis module 40 may set sidewalk indication 50S (50SI) to ‘1’ following ascent event 46ASC detection, or reset sidewalk indication 50S (50SI) to ‘0’ following descent event 46DES detection.

Additionally, or alternatively, server 10 may analyze ramp traversal score 110RS to produce sidewalk indication 50S: As elaborated herein, ramp traversal score 110RS may be calculated iteratively, to include crowd-source information from a plurality of data sources and/or over a long period of time. As shown in FIG. 2A, server 10 may include a sidewalk identification module 120, configured to analyze ramp traversal score 110RS, to determine a location of vehicle 20′ in relation to a sidewalk (e.g., set sidewalk indication 50S), according to this crowd-source information, as elaborated herein.

According to some embodiments, server 10 may communicate, or feedback sidewalk indication 50S to one or more client computing devices 60, which may exhibit or analyze sidewalk indication 50S for various applications.

For example, client computing device 60 may be associated with a third party, such as a commercial entity and/or a municipal authority. In such embodiments, client computing device 60 may keep record of a user's conduct (e.g., occasions of sidewalk riding), and apply required (e.g., punitive) actions based on that conduct. In another example, client computing device 60 may be included in a monitoring system, configured to present locations of vehicles 20′ that are currently, or have historically ridden on sidewalks through the monitored urban space.

Additionally, or alternatively, server 10 may communicate, or feedback sidewalk indication 50S to one or more client computing devices 20, associated with, or mounted on vehicle 20′. In such embodiments, vehicle 20′ may present a notification 230N as an audiovisual or textual message, to indicate that improper conduct (e.g., sidewalk riding) has been monitored by server 10.

As shown in FIG. 2A, client 20 may include, or may be associated with geolocation device or module 210 that may be installed, or mounted on vehicle 20′. Geolocation device 210 may, for example a Global Navigation Satellite System (GNSS) module such as a Global Positioning System (GPS) module, adapted to calculate a geolocation data element 210D representing geolocation of vehicle 20′ based on reception of signals from one or more dedicated satellites, as known in the art.

Additionally, or alternatively, geolocation device 210 may include a beacon receiver, such as a G5 cellular receiver, adapted to calculate a geolocation data element 210D representing geolocation of vehicle 20′ based on triangulation between one or more other G5 cellular transceivers, as known in the art.

Additionally, or alternatively, geolocation device 210 may include any combination of the abovementioned options (e.g., GNSS, GPS, cellular receiver, etc.) to enhance the accuracy of geolocation data 210D, as known in the art.

As shown in FIG. 2A, system 100 may include (e.g., as part of server 10) a geoinformation server 30, also referred to herein as a geoinformation database 30. Alternatively, system 100 (e.g., server 10 and/or client(s) 20) may be communicatively connected with geoinformation server or geoinformation database 30 via a communication network (e.g., via the Internet, via a cellular network, through IoT communication, and the like). Geoinformation server 30 may store, or maintain geoinformation data 30D representing byways in a predefined geographical e.g., urban region. For example, geoinformation data 30 may include street map data 310MP such as polygons (e.g., Geographic Information System (GIS) polylines and points), representing roads and/or sidewalks in the geographical region. Additionally, geoinformation data 30D may include characteristics or patterns of riding on these roads and/or sidewalks referred to herein as sidewalk signatures 350SS and road signatures 350RS respectively. Additionally, geoinformation data 30D may include sidewalk labels 340 SL and/or ramp labels 330RL, representing geographical locations that had been labelled (e.g., by a plurality of clients 20) as locations of ramps and/or sidewalks in the geographical area. Additionally, geoinformation data 30D may include location and/or content of signage in the geographical region and/or location of lampposts in the geographical region, denoted herein as signage data 320SD.

According to some embodiments, system 10 (e.g., client 20 and/or server 10) may communicate with server 30, and obtain therefrom a geoinformation data element 30D representing byways at a predefined geographical region surrounding geolocation 210D of vehicle 20. Based on the ramp traversal score 110RS and geolocation data element 210D, system 10 (e.g., client 20 and/or server 10) may augment geoinformation data 30D to include a label of a ramp 330RL at a position corresponding to geolocation 210D of the vehicle 20′.

For example, if the initial value 110RSS of ramp traversal score 110RS exceeds a predefined threshold value (e.g., ascertaining that vehicle 20′ has traversed a ramp), then client 20 may communicate with database 30, to add a ramp label 330RL to geoinformation data 30D, at a position corresponding to geolocation data element 210D, and may associate or attribute ramp traversal score 110RS to that ramp label 330RL. System 100 may share geoinformation data 30D (e.g., 310MP, 320SD, 330RL, 340SL, 350SS, 350RS) among a plurality of clients 20 (e.g., vehicles 20′). System 100 may thus facilitate a doctrine of crowd sourcing and collaboration for gradually augmenting, or improve mapping of a region.

In another example, if recalculated value 110RSR of ramp traversal score 110RS exceeds a predefined threshold value (e.g., ascertaining that vehicle 20′ has traversed a ramp), then server 10 may communicate with database 30, to add a ramp label 330RL to geoinformation data 30D, at a position corresponding to geolocation data element 210D.

Additionally, or alternatively, augmentation module 150 of server 10 may communicate with database 30 and augment geoinformation data 30D, to include non-ramp impact events 46EI′, thereby adding information regarding bumps or potholes to street map data 310MP.

In other words, a processor (e.g., element 2 of FIG. 1) of client computing device 20 may receive, from a geolocation device 210 a geolocation data element 210D representing geolocation of vehicle 20′, and may obtain, from server computing device 10 a geoinformation data element 30D representing a predefined geographical region surrounding the geolocation of vehicle 20′. Processor 2 of client computing device 20 may transmit ramp traversal score 110RS and geolocation data element 210D to server device 10. Server device 10 may, in turn, employ augmentation module 150, to augment the geoinformation data element 30D, to include a label of a ramp 330RL at a position corresponding to the geolocation 210D of vehicle 20′, based on ramp traversal score 110RS.

Additionally, or alternatively, server 10 may include a ramp identifier module 110, configured to calculate, or recalculate a value 110RSR of ramp traversal score 110RS based on previously labeled ramps 330RL in geoinformation data element 30D.

For example, system 100 (e.g., client 20 and/or ramp identifier module 110 of server 10) may calculate a ramp vicinity score 330RV, representing vicinity of vehicle 20′ to a location of a previously labeled ramp 330RL in geoinformation data element 30D.

Ramp vicinity score 330RV may be calculated, for example as a function of vicinity or distance between a geographical location of vehicle 20′ as represented by geolocation data element 210D, and a geographical location of a ramp, as represented by ramp label 330RL.

Additionally, or alternatively, ramp vicinity score 330RV may be calculated as a function of motion of vehicle 20′ (as represented by data elements 220D or 40MD, e.g., orientation 40MDO, velocity 40MDV, and/or acceleration 40MDA) in relation geographical location of a sidewalk label 340SL and/or ramp label 330RL in geoinformation data element 30D.

As shown in FIG. 3, ramp identifier module 110 may include a machine-learning (ML) based model, referred to herein as a ramp model 112, that may be pretrained, or continuously (e.g., repeatedly, over time) trained to predict, or produce a prediction 110RSP of existence of a ramp, at a specific geographical location, based on incoming data.

For example, ramp model 112 may be trained to receive at least one of (i) a motion data element 40MD (e.g., 40MDO, 40MDA, 40MDV) of a vehicle 20′, (ii) a ramp-vicinity score 330RV of vehicle 20′, and (iii) the initial value 110RSS of ramp traversal score 110RS, to produce a prediction value 110RSP representing a probability that geolocation 210D of vehicle 20′ corresponds to a position of a ramp in the geographical region of geoinformation data element 30D.

Additionally, and as elaborated herein, augmentation module 150 of server 10 may continuously (e.g., repeatedly, over time) augment database 30D to include location of non-ramp impact events 46EI′. Therefore, during training of ML model 112 to identify location of ramps, server 10 may use location of non-ramp impact events 46EI′ as negative examples, defining locations that do not include a ramp.

Ramp identifier module 110 may subsequently infer ramp model 112 on incoming, target data (e.g., motion data 40MD, ramp vicinity score 330RV and/or initial value 110RSS of ramp traversal score 110RS), pertaining to a specific geolocation 210D of vehicle 20′, to predict 110RSP a probability that geolocation 210D of vehicle 20′ corresponds to a ramp in the real world.

According to some embodiments, location of the previously labeled ramp 330RL may correspond to geolocation of one or more other vehicles 20′ (e.g., other than vehicle 20′ for which prediction value 110RSP may currently be calculated). Additionally, or alternatively, location of the previously labeled ramp 330RL may correspond to geolocation of the same vehicles 20′, in a previous point in time. Therefore, it may be appreciated that ramp model 112 may integrate between a first paradigm of determining location of a ramp (e.g., based on detectors 220), and a second paradigm of determining location of a ramp (e.g., based on crowd sourcing, and/or time-based sampling of geoinformation).

Additionally, or alternatively, ramp identifier module 110 may include a rule-base analysis module 114. Rule-base analysis module 114 may be adapted to recalculate ramp traversal score 110RS based on the initial value 110RSS of ramp traversal score 110RS (e.g., obtained from sensor ramp indication module 46) and the predicted ramp traversal score value 110RSP (e.g., obtained from ramp ML model 112). For example, ramp identifier module 110 may produce recalculated value 110RSR of ramp traversal score 110RS, in geolocation 210D as a weighted average between initial value 110RSS and predicted ramp traversal score value 110RSP. Weights of such weighted average function may be updated, or may depend upon a number of clients 20 who have contributed respective initial values 110RSS to a ramp traversal score 110RS of that geolocation 210D.

Additionally, or alternatively, rule base analysis module 114 may receive as input one or more of the inputs of ramp model 112, to fine-tune the weights of the weighted average function: For example, initial values 110RSS of ramp traversal score 110RS that have been recently calculated may have higher weights than those that were calculated a while ago. Similarly, predicted ramp traversal score values 110RSP which were calculated in vicinity to previously labeled ramp locations (having a high ramp vicinity score 330RV) may have higher weights than those that pertain to a more distant location (having a low ramp vicinity score 330RV).

As elaborated herein, server 10 may include an augmentation module 150, communicatively connected to geoinformation database 30. Augmentation module 150 may be configured to augment geoinformation data 30D to include a label of a ramp 330RL at a position corresponding to geolocation of vehicle 20′, based on (i) geolocation data element 210D (e.g., representing geolocation of vehicle 20′), and (ii) recalculated ramp traversal score 110RSR (e.g., when score 110RSR exceeds a predetermined threshold).

Additionally, or alternatively, augmentation module 150 may also augment geoinformation data 30D by associating or attributing recalculated value 110RSR of ramp traversal score 110RS to that ramp label 330RL. System 100 may thus update ramp labels 330RLs of geoinformation data 30D iteratively.

In an initial iteration, one or more clients 20 may calculate an initial value 110RSS of ramp traversal score 110RS, representing probability of a ramp at a specific location, based on mounted sensors 220, and update geoinformation data 30D to add a new ramp label 330RL, and/or attribute ramp traversal score 110RS to a specific ramp label 330RL.

In subsequent iterations, server 10 may recalculate (110RSR) a value of ramp traversal score 110RS of that specific ramp label 330RL, based on (i) previously calculated ramp traversal score value 110RS, and (ii) the predicted value 110RSP from ramp model 112. Augmentation module 150 may update, or augment ramp label 330RL to include recalculated (110RSR) ramp traversal score 110RS in database 30D, thereby continuously refining calculation of ramp traversal score 110RS with each iteration.

As elaborated herein, system 100 may analyze ramp traversal score 110RS to determine location of vehicle 20′ in relation to (e.g., on, or off) a sidewalk, and produce a respective sidewalk indication 50S value. According to some embodiments, system 100 may also analyze ramp traversal score 110RS (e.g., calculate sidewalk indication 50S value) iteratively, in a similar manner as discussed herein in relation to the iterations of ramp traversal score 110RS.

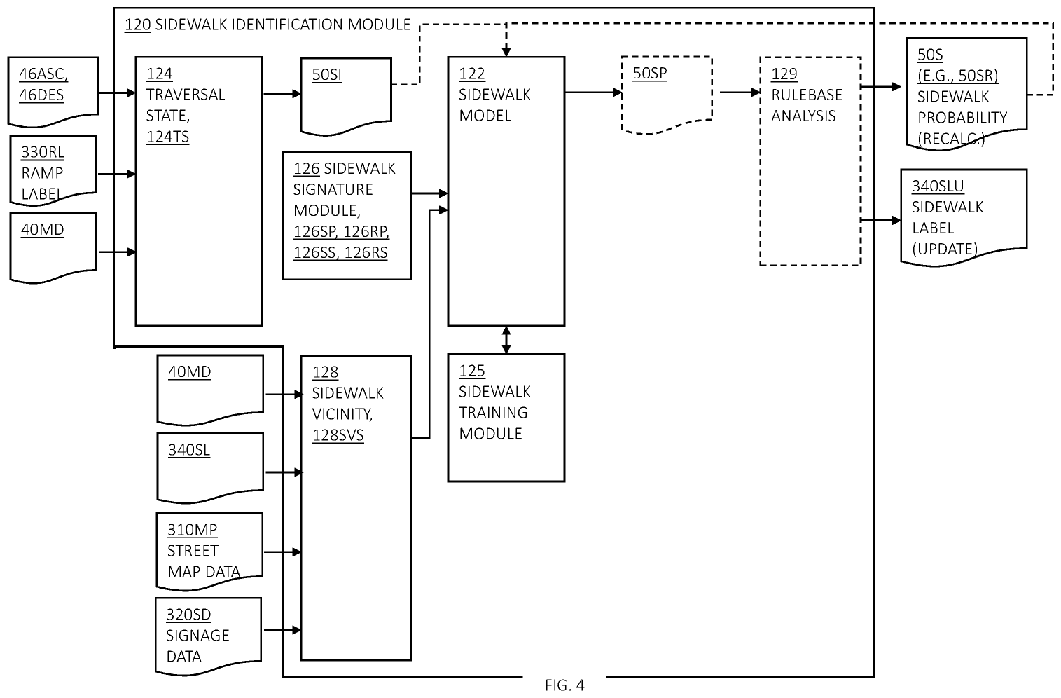

Reference is now made to FIG. 4, which is a block diagram depicting an example of implementation of a sidewalk identification module 120, which may be included in a system 100 for determining location of a vehicle 20′, according to some embodiments of the invention.

Sidewalk identification module 120 may include a traversal state calculation module 124, configured to calculate a traversal state 124TS value, representing a timewise sequence of one or more ramp ascents or ramp descents.

For example, traversal state 124 module may receive one or more ramp ascent 46ASC indications and/or one or more ramp descent 46DES indications, with corresponding timestamps 46TS, and produce traversal state 124TS values representing timewise sequences.

One such timewise sequence may be that of a ramp ascent 46ASC that was not followed by a ramp descent 46DES within a predefined timeframe, thereby indicating that vehicle 20′ is currently on a sidewalk. Another such timewise sequence may be a ramp ascent 46ASC that was followed by ramp descent 46DES within a predefined timeframe, thereby indicating that vehicle 20′ is currently not on a sidewalk. Another such timewise sequence may be a ramp descent 46DES, without ramp ascent 46ASC within a predefined timeframe, thereby indicating that vehicle 20′ is currently not on a sidewalk. Another such timewise sequence may be a ramp descent 46DES followed by ramp ascent 46ASC within a predefined timeframe thereby indicating that vehicle 20′ is currently on a sidewalk.

It may be appreciated that such calculation of timewise sequences, within predefined timeframes may filter-out noisy events such as when vehicle 20′ runs over potholes and small bumps, thereby providing an initial assessment of probability of location of the first vehicle in relation to (e.g., on or off) a sidewalk.

In other words, traversal state calculation module 124 may calculate an initial value of sidewalk probability (also denoted herein as 50SI) based on the traversal state value 124TS. Initial sidewalk probability 50SI may for example, have a Boolean value, where ‘1’ may represent initial identification of vehicle 20′ as riding on the sidewalk, and ‘0’ may represent initial identification of vehicle 20′ as not riding on the sidewalk.

Additionally, or alternatively, traversal state calculation module 124 may calculate traversal state 124TS further based on ramp traversal score 110RS. For example, traversal state calculation module 124 may assign a first value to a sidewalk probability indication 50SI, corresponding to a first value of a ramp traversal score 110RS (e.g., of a last event in the timewise sequence), and assign a second, higher value to a sidewalk probability indication 50SI, corresponding to a second, higher value of ramp traversal score 110RS.

According to some embodiments, augmentation module 150 may subsequently augment, or update geoinformation data element 30D to include a label of a sidewalk 340SL at a location corresponding to geolocation of vehicle 20′, as represented by geolocation data element 210D. Augmentation module 150 may initially assign, or attribute sidewalk label 340SL with a score, based on, or equal to the initial sidewalk probability value 50SI.

Additionally, or alternatively, sidewalk identification module 120 may include a sidewalk vicinity calculation module 128, configured to calculate a sidewalk vicinity score 128SVS based on geolocation data element 210D.

According to some embodiments, sidewalk vicinity calculation module 128 may calculate sidewalk vicinity score 128SVS as representing a metric of distance, or vicinity of vehicle 20′ to a location of a previously labeled sidewalk 340SL in geoinformation data element 30D.

For example, sidewalk vicinity score 128SVS may be calculated as a function of vicinity or distance between a geographical location of vehicle 20′ as represented by geolocation data element 210D, and a geographical location of a sidewalk, as represented by sidewalk label 340SL.

Additionally, or alternatively, sidewalk vicinity score 128SVS may be calculated as a function of vicinity or distance between a geographical location of vehicle 20′ as represented by geolocation data element 210D, and a geographical location of a sidewalk, as represented by street map data element 310MP.

Additionally, or alternatively, sidewalk vicinity score 128SVS may be calculated as a function of vicinity or distance between a geographical location of vehicle 20′ as represented by geolocation data element 210D, and location of relevant signage (e.g., signage defining a road intersection, signage defining traffic regulations, etc.), as represented by signage data element 320SD.

Location of the previously labeled sidewalk 340SL may correspond to geolocation of one or more other vehicles 20′ (e.g., other than vehicle 20′ for which prediction value 50SP may currently be calculated). Additionally, or alternatively, location of the previously labeled sidewalk 340SL may correspond to geolocation of the same vehicles 20′, in a previous point in time. Therefore, it may be appreciated that sidewalk model 122 may integrate between a first paradigm of determining probability of a sidewalk (e.g., based detection of ramps), and a second paradigm of determining probability of a sidewalk (e.g., based on crowd sourcing, and/or time-based sampling of geoinformation).

In another example, sidewalk vicinity score 128SVS, may represent a metric of distance, or vicinity of vehicle 20′ (e.g., expressed by 210D) to a location of a sidewalk in a street map 310MP data element (in geoinformation data element 30D) at a region surrounding the location of vehicle 20′.

In yet another example, sidewalk vicinity score 128SVS may be calculated as a function of motion of vehicle 20′ (e.g., 220D or 40MD (40MDO, 40MDV, 40MDA)) in relation geographical location of a sidewalk label 340SL, a ramp label 330RL, and/or a sidewalk polygon (e.g., 310MP) in geoinformation data element 30D.

For example, sidewalk vicinity calculation module 128 may analyze motion data elements 40MD to determine that vehicle 20′ is riding toward a geographical location of a sidewalk label 340SL, a ramp label 330RL, and/or a sidewalk polygon (e.g., 310MP), and may consequently increase sidewalk vicinity score 128SVS. In a complementary manner, sidewalk vicinity calculation module 128 may determine that vehicle 20′ is riding away from a geographical location of a sidewalk label 340SL, a ramp label 330RL, and/or a sidewalk polygon (e.g., 310MP), and may consequently decrease sidewalk vicinity score 128SVS.

As shown in FIG. 4, sidewalk identification module 120 may include an ML based model, referred to herein as sidewalk model 122, that may be pretrained, or continuously (e.g., repeatedly, over time) trained to predict, or produce a prediction 50SP of existence of a sidewalk, at a specific geographical location, based on incoming data.

For example, sidewalk model 122 may be trained to receive at least one of (i) a sidewalk vicinity score 128SVS of vehicle 20′, (ii) a traversal state 124TS value of vehicle 20′, and (iii) the initial value 50SI of sidewalk probability value 50S, to recalculate sidewalk probability value 50S (now 50SR).

Sidewalk identification module 120 may subsequently infer sidewalk ML model 122 on incoming, target data (e.g., (i) sidewalk-vicinity score 128SVS, (ii) traversal state value 124TS, (iii) initial sidewalk probability value 50SI) pertaining to a specific geolocation 210D of vehicle 20′, to recalculate sidewalk probability value 50S (now 50SR), representing probability that vehicle 20′ is currently on a sidewalk.

Additionally, or alternatively, sidewalk model 122 may be trained to receive at least one of (i) a sidewalk vicinity score 128SVS of vehicle 20′, (ii) a traversal state 124TS value of vehicle 20′, and (iii) a current or initial 50SI value of sidewalk probability 50S, to produce a predicted value 50SP representing a probability that geolocation 210D of vehicle 20′ corresponds to a location of a sidewalk in the geographical region of geoinformation data element 30D.

Sidewalk identification module 120 may subsequently infer sidewalk ML model 122 on incoming, target data (e.g., (i) sidewalk-vicinity score 128SVS, (ii) traversal state value 124TS, (iii) a current or initial 50SI sidewalk probability value 50S) pertaining to a specific geolocation 210D of vehicle 20′, to produce a predicted value 50SP, representing a probability that geolocation 210D of vehicle 20′ corresponds to a ramp in the real world (e.g., that vehicle 20′ is currently on a sidewalk).

Additionally, or alternatively, sidewalk identification module 120 may include a rule-base analysis module 129, adapted to recalculate sidewalk probability value 50S based on the initial value 50SI, of sidewalk probability 50S (e.g., obtained from client 20 and/or from traversal state calculation module 124) and predicted sidewalk probability 50P (e.g., obtained from sidewalk ML model 122). For example, rule-base analysis module 129 may produce recalculated value 50SR of sidewalk probability 50S, in geolocation 210D as a weighted average between initial value 50SI and predicted value 50SP.

Additionally, or alternatively, rule-base analysis module 129 may be adapted to recalculate (50SR) sidewalk probability 50S based on initial value 50SI (e.g., obtained from traversal state module 124) and the predicted sidewalk score value 50SP (e.g., obtained from sidewalk ML model 112).

For example, sidewalk identifier module 120 may iteratively produce recalculated value 50SR in geolocation 210D as a weighted average between initial value 50SI and predicted sidewalk score value 50SP. Weights of such weighted average function may be updated, or may depend upon a number of clients 20 who have contributed to respective initial values 50SI to a sidewalk score 50S of that geolocation 210D.

Additionally, or alternatively, rule base analysis module 129 may receive as input one or more of the inputs of sidewalk model 122, to fine-tune the weights of the weighted average function: For example, initial values 50SI of that have been recently calculated may have higher weights than those that were calculated a while ago. Similarly, predicted sidewalk score values 50SP which were calculated in vicinity to previously labelled sidewalk locations (having a high sidewalk vicinity score 128SVS) may have higher weights than those that pertain to a more distant location (having a low sidewalk vicinity score 128SVS).

According to some embodiments, augmentation module 150 may augment geoinformation data to include at a sidewalk label 340SL based on geolocation data element 210D and sidewalk probability 50S. For example, when sidewalk probability 50S exceeds a predetermined threshold augmentation module 150 may communicate an update message 340SLU to database 30, which may include geolocation data element 210D and sidewalk probability 50S. Server 30 may, in turn, update geoinformation data 30D so as to include a new, or updated sidewalk label 340SL that pertains to a geographical location that corresponds to geolocation data element 210D, and is attributed with sidewalk probability 50S.

As elaborated herein, system 100 may analyze ramp traversal score 110RS to determining location of vehicle 20′ in relation to (e.g., on, or off) a sidewalk, and produce a respective sidewalk indication 50S value. According to some embodiments, system 100 may also analyze ramp traversal score 110RS (e.g., calculate sidewalk indication 50S value) iteratively, in a similar manner as discussed herein in relation to the iterations of ramp traversal score 110RS.

In other words, system 100 may update sidewalk labels 340SL of geoinformation data 30D iteratively.

In an initial iteration, one or more clients 20, and/or traversal state module 124 may calculate an initial value 50SI of sidewalk probability 50S, representing probability of existence at a specific location, as elaborated herein. Server 10 may update geoinformation data 30D to add a new sidewalk label 340SL, and/or attribute sidewalk probability 50S to a specific sidewalk label 340SL.

In subsequent iterations, server 10 may recalculate (50SR) a value of sidewalk probability 50S of that specific sidewalk label 340SL, based on (i) previously calculated sidewalk probabilities 50S, and (ii) the predicted value 50SP from sidewalk model 122. Augmentation module 150 may update, or augment sidewalk label 340SL to include recalculated (50SR) sidewalk probabilities 50S in geoinformation database 30D, thereby continuously refining calculation of sidewalk probabilities 50S with each iteration.

As shown in FIG. 4, sidewalk identification module 120 may include a sidewalk signature module 126. According to some embodiments sidewalk signature module 126 may continuously (e.g., repeatedly, over time) record information that is descriptive of sidewalk riding, denoted herein as sidewalk signature 126SS.

As elaborated herein, server 10 may accumulate, and maintain (e.g., in database 6 of FIG. 1) sidewalk signature 126SS pertaining to one or more (e.g., each) vehicle 20′. Augmentation module 150 of server 10 may communicate with geoinformation database 30D and augment its content (e.g., signature 350SS) to include the accumulated sidewalk signature 126SS.

Additionally, or alternatively, and as depicted in FIG. 4, server 10 may use sidewalk signature 126SS as input for sidewalk ML model 122, to ascertain a location of vehicle 20′ in relation to a sidewalk (50SP), e.g., whether vehicle 20′ is currently riding on a sidewalk.

For example, when a value of sidewalk probability 50S surpasses a predefined threshold (e.g., providing initial indication that vehicle 20′ is currently riding a sidewalk), sidewalk signature module 126 may calculate one or more sidewalk-riding parameters 126SP, based on the motion data elements (220D, 40MDA, 40MDO).

Sidewalk-riding parameters 126SP may include, for example sampled acceleration data 40MDA, sampled gyroscope (orientation) data 40MDO, sampled velocity data 40MDV, frequency (e.g., Fast Fourier Transform (FFT)) based representations of 40MDO, 40MDA and/or 40MDV, and corresponding geolocation data 210D. Sidewalk signature module 126 may analyze the accumulated sidewalk-riding parameters 126SP, to obtain one or more signature data elements 126SS representing a pattern of sidewalk riding.

For example, riding a sidewalk such as a tiled sidewalk may be characterized by a specific distribution of accelerometer data frequencies, corresponding to traversal over gaps between tiles. In such embodiments, signature data elements 126SS may include information representing distribution and/or amplitude of frequency-domain (e.g., FFT) representation of sampled acceleration data 40MDA.

In another example, riding a crowded sidewalk may require excessive maneuvering among pedestrians, and may therefore be characterized by a signature or pattern 126SS representing low velocity 40MDV, and excessive changes in orientation data 40MDO. Additional signature or patterns of sidewalk riding 126SS may also be possible.

Based on the geolocation data 210D (e.g., indicating a location corresponding to signature or pattern 126SS), server 10 may augment (by module 150) geoinformation data element 30D (e.g., 350SS) to include sidewalk signature 126SS. In other words, geoinformation data 350SS may now include representation of the one or more sidewalk-riding parameters 126SP, at a location corresponding to geolocation 210D of vehicle 20′.

Additionally, or alternatively, when a value of sidewalk probability 50S is below a predefined threshold (e.g., providing initial indication that vehicle 20′ is currently riding a road), sidewalk signature module 126 may calculate one or more road-riding parameters 126RP, based on the motion data elements (220D, 40MDA, 40MDO). This may be done in a similar manner as described above, in relation to sidewalk riding parameters 126SP, and will not be repeated here.

Sidewalk signature module 126 subsequently calculate a road-riding signature 126RS, and augment (by module 150) geoinformation data 30D to include road signature 350RS, based on the calculated one or more road-riding parameters 126RP. This may be done in a similar manner as described above, in relation to sidewalk riding signature 126SS and 350SS, and will not be repeated here.

According to some embodiments, sidewalk module 120 calculate, and subsequently compare or analyze a current sidewalk riding signature 126SS vis-à-vis stored signatures 350SS/350RS, to recalculate or fine-tune sidewalk probability 50S (e.g., improving indication of whether vehicle 20′ is currently riding a sidewalk).

In other words, sidewalk signature module 126 may calculate one or more current riding parameters 126SP and/or current signature or patterns of sidewalk riding 126SS of a specific vehicle 20′, based on motion data 220D. Sidewalk module 120 may extract at least one sidewalk signature or parameter 350SS, and/or one road-riding signature or parameter 350RS from geoinformation database 30D, based on the geolocation data 210D (e.g., corresponding to the same location). Sidewalk module 120 may subsequently compare, or analyze the current parameter(s) 126SP and/or current signatures 126SS with the extracted signatures or parameters 350SS/350RS, to ascertain whether a current riding of vehicle 20′ matches sidewalk signature 350SS (thereby enhancing indication that vehicle 20′ is currently riding a sidewalk) and/or ascertain whether a current riding of vehicle 20′ matches road signature 350RS (thereby enhancing indication that vehicle 20′ is currently not riding a sidewalk).

Additionally, or alternatively, and as shown in FIG. 4, sidewalk module 120 may further infer sidewalk ML model 122 on at least one of: (i) the one or more current road-riding parameters 126RP, (ii) the one or more current road-riding signatures 126RS, (iii) the one or more current sidewalk-riding parameters 126RP, (iv) the one or more current sidewalk-riding signatures 126SS, and (v) an extracted sidewalk signature 350SS or road signature 350RS of database 30D, to recalculate, or predict sidewalk probability value 50SP.

As elaborated herein, and shown in FIG. 2A, identification of traversal of a ramp by module 110 may contribute to identification of riding a sidewalk by sidewalk module 120. In a complementary manner, and as also shown by FIG. 2A, identification of riding a sidewalk by sidewalk module 120 may contribute, via crowd sourcing logic (e.g., geoinformation augmentation module 150), to identification of location of ramps in the monitored urban area.

For example, during inference of ML based ramp model 112, server 10 may provide sidewalk probability value 50S (e.g., 50SR) as input to ramp model 112. In other words, server 10 may further infer ML based ramp model 112 on sidewalk probability value 50S (e.g., 50SR), to recalculate ramp traversal score 110RS (e.g., 110RSP).

As shown in FIGS. 2A and 2B, client module 20 may include a proxy module 240, which may enable clients 20 to collaborate with (e.g., query or update) augmentation module 150 of server 10 either online, or offline, on data that is relevant to that client 20.

For example, a client 20 may provide information which may indicate location of a ramp, a non-ramp “bump”, and/or sidewalk. Proxy module 240 may communicate this information to server 10 at the current location and/or time (hence, “online”), or in relation to a previous location and/or time (hence “offline”). Augmentation module 150 may subsequently augment, or update geoinformation data element 30D to include a label representing a ramp, a non-ramp “bump”, and/or sidewalk in the relevant location and/or time.

According to some embodiments, proxy module 240 may communicate a location of client 20 to server 10, to query, and obtain a portion 30D′ of geoinformation data element 30D that is relevant, or surrounding the client's 20 current location. Additionally, or alternatively, proxy module 240 may communicate a location of client 20 to server 10, to query, and obtain any portion of ramp identification module 110 (e.g., sidewalk model 112) of and/or sidewalk identification module 120 (e.g., sidewalk model 122). In such embodiments, client 20 may perform the functions of ramp identification module 110 and/or sidewalk identification module 120, in the context of the geographical area surrounding client 20 (vehicle 20′), and identify sidewalk riding, as elaborated herein (e.g., in relation to FIGS. 3 and 4).

As elaborated herein, sidewalk module 120 may calculate sidewalk probability values 50S pertaining to a specific client 20 or user, e.g., rider of a specific vehicle 20′. Additionally, sidewalk module may calculate a sidewalk riding pattern 126SS which characterizes the rider of the specific vehicle 20′. Sidewalk module 120 may thereby calculate a user profile data element 50P, which may have a numerical value representing a riding behaviour of the specific user, based on data elements 126SS and 50S.

For example, frequent occurrences of sidewalk probability values 50S of a specific client 20, which surpass a predefined threshold may represent behaviour of a reckless sidewalk rider. Sidewalk module 120 may calculate profile data element 50P according to a measure of such frequency, to reflect a level of recklessness of that driver.

Additionally, or alternatively, specific sidewalk riding pattern 126SS (e.g., frequent zig-zagging, high velocities and/or accelerations) may also represent behaviour of a reckless sidewalk rider. Sidewalk module 120 may thus calculate profile data element 50P further according to sidewalk riding pattern 126SS, to reflect further a level of recklessness of that driver.

Application server 10 may expose specific Application Programming Interface (API) commands, to facilitate usage accumulated data (e.g., profile data elements 50P) by one or more predefined computing devices 70, to utilize the user's profile and encourage safe riding. For example, computing devices 70 may pertain to a commercial third party or a municipality. Computing devices 70 may query server 10 to obtain profiles 50P of specific clients 20 (or vehicles 20′). When a profile 50P of a specific client corresponds to reckless or responsible behaviour, computing devices 70 may apply respective punitive or commending actions due to this conduct.

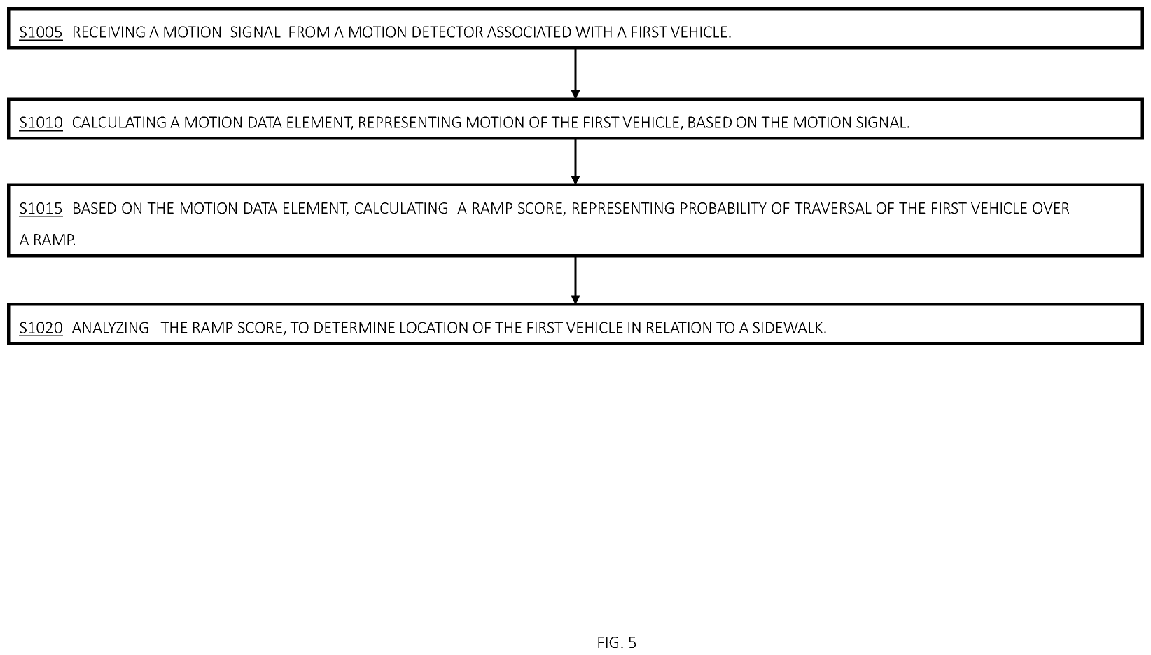

Reference is now made to FIG. 5, which is a flow diagram depicting a method of determining location of a vehicle by at least one processor (e.g., processor 2 of FIG. 1), according to some embodiments.

As shown in steps S1005 and S1010, processor 2 may receive a motion signal 220S from a motion detector 220 associated with a vehicle 20′. Processor 2 may calculate a motion data element 220D, representing motion characteristics (e.g., 40MDO, 40MDA, 40MDV) of vehicle 20′, based on motion signal 220S.

As shown in steps S1015, based on motion data element 220D, processor 2 may calculate a ramp traversal score 110RS, representing probability of traversal of the vehicle 20′ over a ramp. For example, as elaborated herein (e.g., in relation to FIG. 3), processor 2 may infer an ML based ramp model to predict ramp traversal score 110RS.

As shown in steps S1020, processor 2 may analyze ramp traversal score 110RS to determine location of vehicle 20′ in relation to a sidewalk (e.g., whether vehicle 20′ is currently riding on a sidewalk).

For example, and as elaborated herein (e.g., in relation to FIG. 4) this analysis may include identifying a traversal state 124TS, indicating a latest traversal, or ascent of vehicle 20′ to a sidewalk, via a ramp. This is may be referred to as an initial assertion of sidewalk riding, and is denoted herein as sidewalk probability 50SI.

Additionally, or alternatively, as elaborated herein (e.g., in relation to FIG. 4) this analysis may also include inference of a sidewalk ML based model 122 on derivatives of ramp traversal score 110RS (e.g., 50SI, ramp labels 330RL, sidewalk labels 340SL), to further update or predict sidewalk probability 50S (denoted herein as 50SP).

Additionally, or alternatively, as elaborated herein (e.g., in relation to FIG. 4) this analysis may also include iterative inference of sidewalk ML based model 122 on derivatives of predicted sidewalk probability 50SP (denoted herein as 50SR).

Additionally, or alternatively, as elaborated herein (e.g., in relation to FIG. 4) this analysis may also include iterative augmentation of geoinformation database 30D, and inference of sidewalk ML based model on sidewalk-riding, and road-riding signatures and parameters 126SP, 126RP, 126SS, 126RS.

Embodiments of the invention may include a practical application in the technological field of smart cities, and urban operations control. As elaborated herein, the novel integration of analysis of vehicle-mounted sensor data with an urban-scale crowd-sourcing paradigm may be used to improve urban resource control and maintenance, as well as traffic law enforcement.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of determining a vehicle's location by at least one processor, the method comprising:
receiving a geolocation data element representing geolocation of a first vehicle;
receiving a motion signal from a motion detector associated with the first vehicle;
calculating a motion data element, representing motion characteristics of the first vehicle, based on the motion signal;
based on the motion data element, calculating an initial value of a ramp traversal score, representing probability of traversal of the first vehicle over a ramp;
based on the geolocation data element, calculating a ramp-vicinity score representing vicinity of the first vehicle to a location of a ramp;
inferring a ramp machine-learning (ML) based model on the ramp-vicinity score and at least one of (i) the motion data element and (ii) the initial value of the ramp traversal score, to update the ramp traversal score; and
determining location of the first vehicle in relation to a sidewalk based on the updated ramp traversal score.

2. The method of claim 1, further comprising:
obtaining a geoinformation data element representing byways at a predefined geographical region;
based on (i) the ramp traversal score, and (ii) the geolocation data element, augmenting the geoinformation data element to include a label of a ramp at a position corresponding to the geolocation of the first vehicle; and
calculating the ramp-vicinity score based on location of a previously labeled ramp in the augmented geoinformation data element.

3. The method of claim 1, wherein the motion detector is installed on the first vehicle, and is selected from a list consisting of an accelerometer, configured to produce an acceleration motion signal, and a gyroscope configured to produce an orientation motion signal, and wherein the motion data element is respectively selected from a list consisting of an acceleration data element and an orientation data element.

4. The method of claim 1, wherein calculating the ramp traversal score comprises:
identifying, in the acceleration data, an impact event representing acceleration of the first vehicle, characteristic of impact with an edge of a ramp;
identifying, in the orientation data, a slope event representing orientation of the first vehicle, characteristic of a slope of a ramp; and
calculating an initial value of the ramp traversal score based on the slope event and the impact event.

5. The method of claim 4, further comprising:
assigning a first timestamp to the impact event;
assigning a second timestamp to the slope event; and
calculating the initial value of the ramp traversal score further based on the first timestamp and second timestamp.

6. The of claim 4, further comprising:
obtaining a geoinformation data element representing byways at a predefined geographical region;
receiving, from a geolocation device, a geolocation data element representing geolocation of the first vehicle; and
based on the ramp traversal score and the geolocation data element, augmenting the geoinformation data element to include a label of a ramp at a position corresponding to the geolocation of the first vehicle.

7. The method of claim 6, wherein calculating the ramp traversal score further comprises:
based on the geolocation data element, calculating a ramp-vicinity score, representing vicinity of the first vehicle to a location of a previously labeled ramp in the geoinformation data element; and
inferring a first machine-learning (ML) based model on at least one of (i) the motion data element of the first vehicle, (ii) the ramp-vicinity score, and (iii) the initial value of the ramp traversal score, to recalculate the ramp traversal score.

8. The method of claim 7, wherein the location of the previously labeled ramp corresponds to geolocation of one or more second vehicles.

9. The method of claim 7, further comprising augmenting the geoinformation data element to include a label of a ramp at a position corresponding to the geolocation of the first vehicle, based on (i) the recalculated ramp traversal score and (ii) the geolocation data element.

10. The method of claim 7, wherein determining location of the first vehicle in relation to the sidewalk comprises:
based on the ramp traversal score, calculating a traversal state value, representing a timewise sequence of one or more ramp ascents or ramp descents; and
based on the traversal state value, calculating an initial value of sidewalk probability, representing probability of location of the first vehicle on the sidewalk.

11. The method of claim 10, wherein the timewise sequence is selected from a list consisting of: ramp ascent, ramp ascent followed by ramp descent within a predefined timeframe, ramp descent, and ramp descent followed by ramp ascent within a predefined timeframe.

12. The method of claim 9 further comprising: based on (i) the initial sidewalk probability value, and (ii) the geolocation data element, augmenting the geoinformation data element to include a label of a sidewalk, corresponding to geolocation of the first vehicle.

13. The method of claim 12, further comprising:
based on the geolocation data element, calculating a sidewalk-vicinity score, representing vicinity of the first vehicle to a location of a previously labeled sidewalk in the geoinformation data element; and
inferring a second ML based model on at least one of (i) the sidewalk-vicinity score, (ii) the traversal state value, and (iii) the initial sidewalk probability value, to recalculate the sidewalk probability value.

14. The method of claim 13, wherein the location of the previously labeled sidewalk corresponds to geolocation of one or more second vehicles.

15. The method of claim 13, further comprising:
when the sidewalk probability value surpasses a predefined threshold, calculating one or more sidewalk-riding parameters, based on the motion data element; and
based on the geolocation data, augmenting the geoinformation data element to include a sidewalk signature, representing the one or more sidewalk-riding parameters, at a location corresponding to the geolocation of the first vehicle.

16. The method of claim 15, further comprising:
calculating one or more current riding parameters based on the motion data; and
extracting at least one sidewalk signature from the geoinformation data element based on the geolocation data,
wherein inferring the second ML model further comprises inferring the second ML model on (i) the one or more current riding parameters, and (ii) the extracted sidewalk signature, to recalculate the sidewalk probability value.

17. The method of claim 16, wherein inferring the first ML based model further comprises inferring the first ML based model on the sidewalk probability value, to recalculate the ramp traversal score.

18. A system for determining a vehicle's location, the system comprising:
a motion detector associated with a first vehicle, and configured to produce a motion signal;
a first client computing device, associated with the first vehicle, said first client computing device comprising a non-transitory memory device, wherein modules of instruction code are stored, and at least one first processor, associated with the memory device, wherein the at least one first processor is configured to execute the modules of instruction code, whereupon execution of said modules of instruction code, the at least one first processor is configured to:
receive a motion signal from the motion detector;
calculate a motion data element, representing motion characteristics of the first vehicle, based on the motion signal;
based on the motion data element, calculate a ramp traversal score, representing probability of traversal of the first vehicle over a ramp; and
analyze the ramp traversal score, to determine location of the first vehicle in relation to a sidewalk.

19. The system of claim 18, wherein the at least one first processor is further configured to:
receive, from a geolocation device, a geolocation data element representing geolocation of the first vehicle;
obtain, from a server computing device, a geoinformation data element representing a predefined geographical region surrounding the geolocation of the first vehicle; and
transmit the ramp traversal score and the geolocation data element to the server computing device,
wherein the server computing device is configured to augment the geoinformation data element to include a label of a ramp at a position corresponding to the geolocation of the first vehicle, based on the ramp traversal score.

20. A system for determining a vehicle's location, the system comprising:
a server computing device, comprising a non-transitory memory device, wherein modules of instruction code are stored, and at least one processor, associated with the memory device, wherein the at least one processor is configured to execute the modules of instruction code, whereupon execution of said modules of instruction code, the at least one processor is configured to:
maintain a geoinformation data element, representing position of one or more ramps at a predetermined geographical region;
receive, from a first client computing device associated with a first vehicle, a geolocation data element representing geolocation of the first vehicle;
receive, from the first client computing device, a ramp traversal score, representing probability of traversal of the first vehicle over a ramp; and
based on the ramp traversal score, augmenting the geoinformation data element, to include a label of a ramp at a position corresponding to the geolocation of the first vehicle, based on the ramp traversal score.
